(19) United States
(12) Patent Application Publication
(10) Pub. No.: US 2009/0077372 A1
(43) Pub. Date: Mar. 19, 2009

(54) PROCESS FOR TRANSMITTING AN ELECTRONIC MESSAGE IN A TRANSPORT NETWORK

(75) Inventors: Markus DANIELI, Gestratz (DE); Frank SCHNEKENBUEHL, Salem (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 12/209,785

(22) Filed: Sep. 12, 2008

(30) Foreign Application Priority Data
Sep. 14, 2007 (DE) 102007043892.5-31

(51) Int. Cl. H04L 9/00

(52) U.S. Cl. 713/153

(57) ABSTRACT

In a process for transmitting an electronic message that contains protected and unprotected content, the authenticity of the header elements HE is ensured by obtaining a subsequent authenticity verification of the sender. For this purpose, a checking device which is inserted into the transmission network transforms the header elements of the original message into a new message whose contents are protected by known encryption methods. The new message is sent back to the sender which decrypts it and checks the header elements. If the sender verifies the authenticity of the transmitted data, the header elements on which the original message is based are also considered to be verified. According to the invention, the sender who sends the message, and is later requested to verify its authenticity, may be the mail server (Message Transfer Agent “MTA”) as well as the client of the MTA (and thus, the author of the message, who first forwards the message to the MTA).

### BACKGROUND AND SUMMARY OF THE INVENTION

This application claims the priority of German patent document application no. 10 2007 043 892.5-31, filed Sep. 14, 2007, the disclosure of which is expressly incorporated by reference herein.

The invention relates to a process for transmitting an electronic message in a transport network.

When transmitting electronic messages (email) using currently common standards (for example, X.400/SMTP) and methods, header elements (HE) are used for the transport of auxiliary information. Such auxiliary information may comprise, for example, a sender address, recipient addresses, date/time as well as, in military/security-relevant environments, also priority levels, validity period, alternative recipients and a security classification VS. (The header elements are differently coded and transmitted depending on the protocol that is used.) The information contained in the header is freely accessible because additional header elements (HE), such as trace information of the processing message transfer agents (MTA), also have to be added during the transport operation.

An example of a operational environment is illustrated in FIG. 1, for explaining the resulting problems in detail. In the illustrated security-relevant environment, the transport network T is divided into two subareas T1, T2 with different security classification levels or different security policies. In the illustrated example, the left subarea T1 is the one with a higher security classification in comparison with the right subarea T2. For defining and controlling the message exchange between the subareas T1, T2, special gateways G are used. These gateways assess the individual messages and then transmit them, as required, into the other security area. The decision of whether a message is transmitted into the other area is made based on the HE of the respective message.

The following steps take place with respect to the sequence of operation:

### 1. Sending

Sender S creates an electronic message N1 and addresses it to a recipient E. He also defines selected header elements HE, such as the subject, or the VS classification. It is possible for the sender to encrypt the message body for the recipient E or to digitally sign the message. Already established methods, such as S/MIME or PGP can be used for the digital signature and the encryption. The transport system T transits the message on the basis of the address information in the header elements to the gateway G.

### 2. Assessing by Gateway G (Transmitting or Rejecting)

The assessment takes place particularly by means of the security classification which is contained in the header of the message. If the header elements HE correspond to the defined security policy, the message is transmitted into the other security area T2, otherwise the message is rejected at the gateway.

### 3. Delivering

The message is transported to the recipient E by the transport system in the other area.

The fact that the authenticity of the header elements is not ensured, and therefore a manipulation of the header elements can not be discovered, is problematic in the case of this process. If, for example, the header element “VS-classification level” is manipulated during the transmission, confidential information may reach the unclassified area contrary to the existing security policy.

One object of the present invention therefore, is to provide a process for transmitting electronic information based on current standards, by which the authenticity of the header elements can be guarantied.

This and other objects and advantages are achieved by the method according to the invention, in which the authenticity of the header elements HE is ensured by obtaining a subsequent authenticity verification of the sender. This is achieved by a transformation of the header elements of the original message into a new message whose contents are protected by methods know per se for encryption (and by an optional digital signature). If the sender verifies the authenticity of the transmitted data, the header elements on which the original message is based are also considered to be verified. In the context of this invention, the sender who sends the message, and is later requested to verify the authenticity of the message may be the mail server (Message Transfer Agent “MTA”) as well as the client of the MTA (and thus, the author of the message, who first forwards the message to the MTA).

The existing system consisting of the sender, the network and the recipient is expanded by a checking device which forwards the original message only after an authenticity verification by the sender.

Advantages of this solution are:
header elements HE are verified;
manipulations of header elements can be detected;
no changes of existing infrastructures are required;
no breach of established standards for the message transmission are caused;
prevalent technologies can be used for the digital signing and encryption; and
economical handling of transport resources is achieved.

In the initially described operational environment, with network areas of different security levels and gateways providing the transition, the checking device is connected ahead of the gateway. With respect to equipment, the checking device can be integrated in the gateway. Checking at the gateway, and possible forwarding to the recipient, will take place only after the checking device has verified the authenticity of the header elements HE.

In a particularly advantageous embodiment, the original message generates a “fingerprint” (a characteristic which unambiguously identifies the message), which is also sent back to the sender. The fingerprint may, for example, be derived from the message, particularly by forming a hash value in a manner known to those skilled in the art. As an alternative, a random number may be generated, completely independently of the message. For verifying the authenticity of the header elements, it is sufficient for the sender to send only the fingerprint back to the checking device, by which the latter can identify the original message.

The process according to the invention can also be used for the protection against Spam, in which case the authenticity verification is obtained from the sending MTA. Each MTA stores the message IDs of the messages which it sends, and verifies them upon request.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an operational environment for transmitting electronic messages according to the state of the art, as described in the introduction to the specification;

FIG. 2 shows an operational environment for applying the process according to the invention;

FIGS. 3a-3c show the sequence of the process according to the invention in a sequence diagram, including the message sending and verification request operation (FIG. 3a), the verification operation FIG. 3b), and the assessment and delivery operation (FIG. 3c); and

FIG. 4 illustrates the sequence of the process according to the invention with an assumed manipulation of the message during transmission.

### DETAILED DESCRIPTION OF THE DRAWINGS

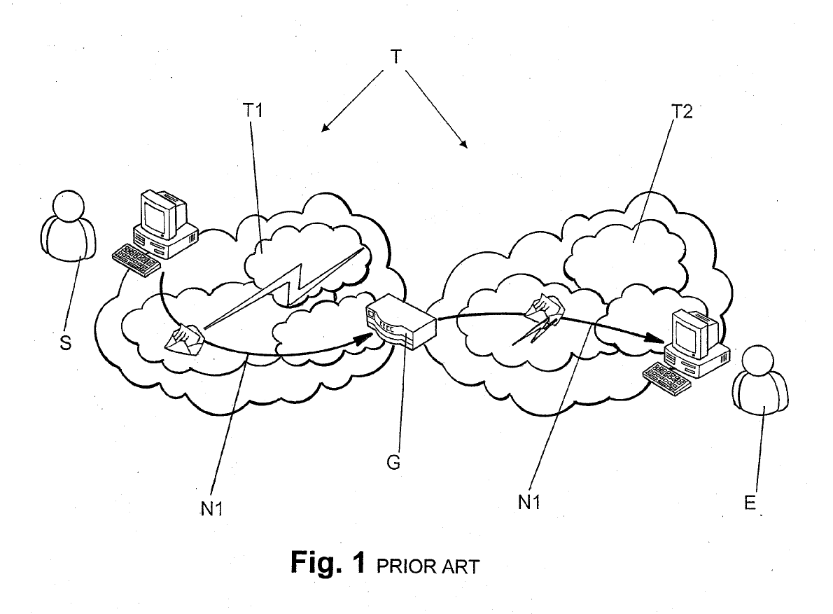

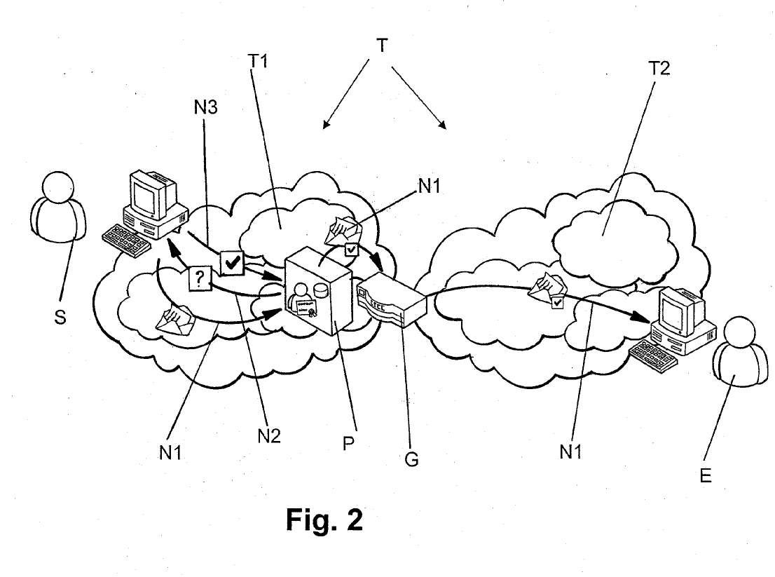

The operational environment for the process according to the invention is illustrated in FIG. 2; it differs from the operational environment of FIG. 1 (prior art) in that the checking device P has been added. It has the object of obtaining and intermediately storing the authenticity verification for the original message N1. Since the checking device P and the gateway G can be implemented in a single entity, an assessment can be carried out in the gateway G on the basis of the verified header elements HE.

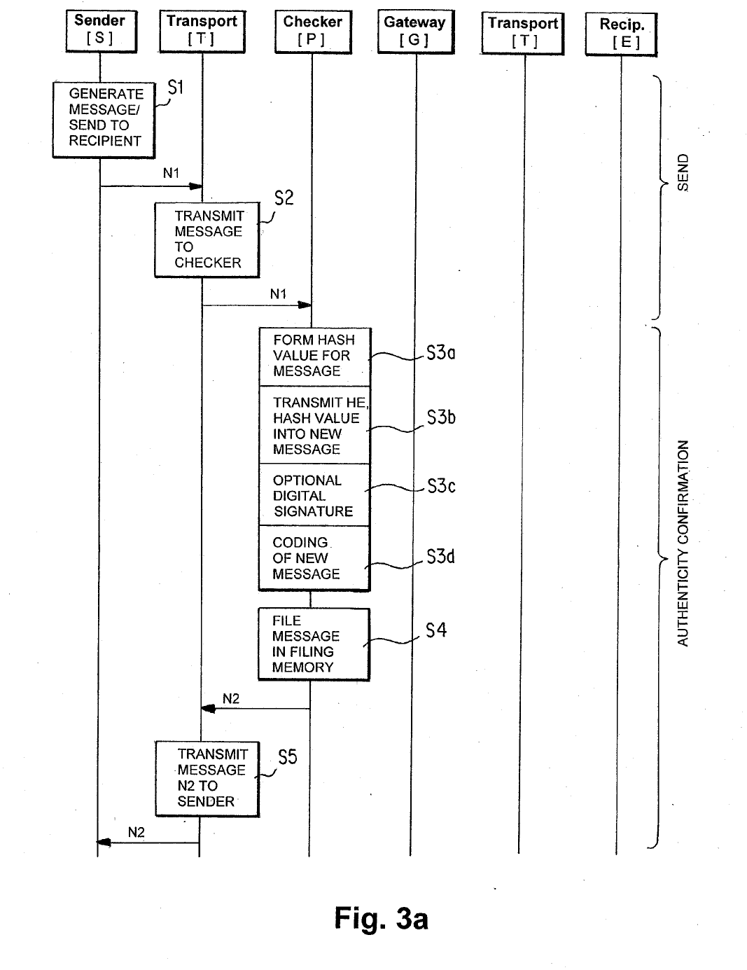

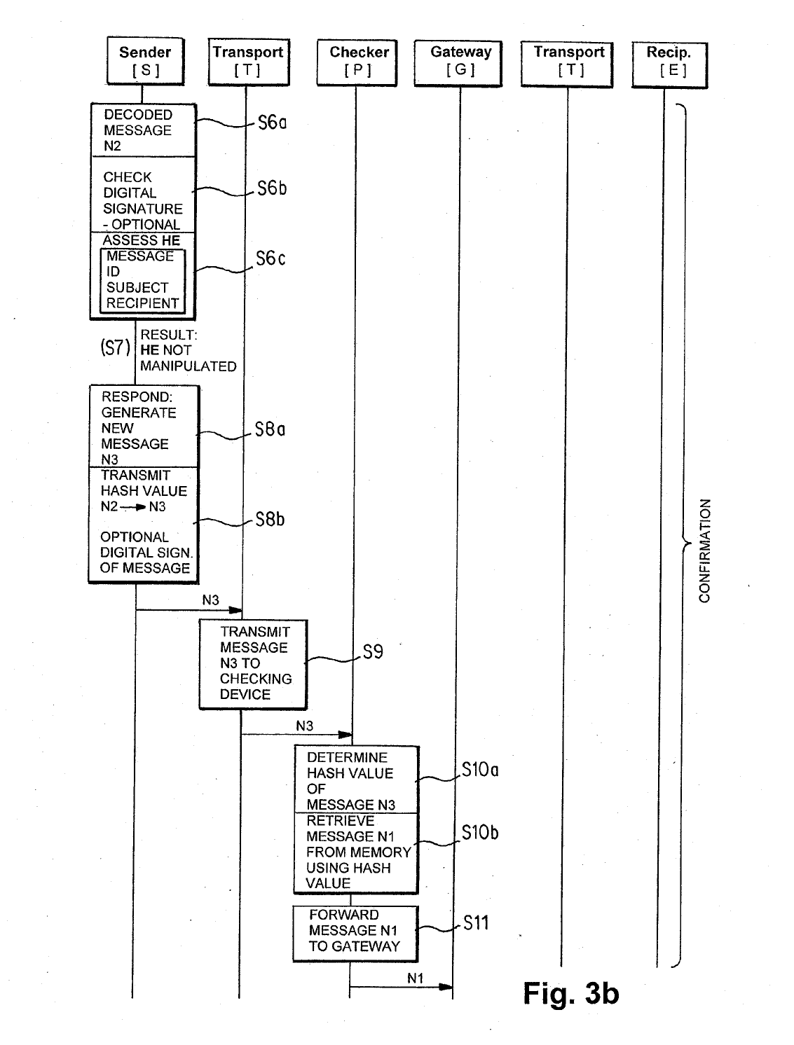

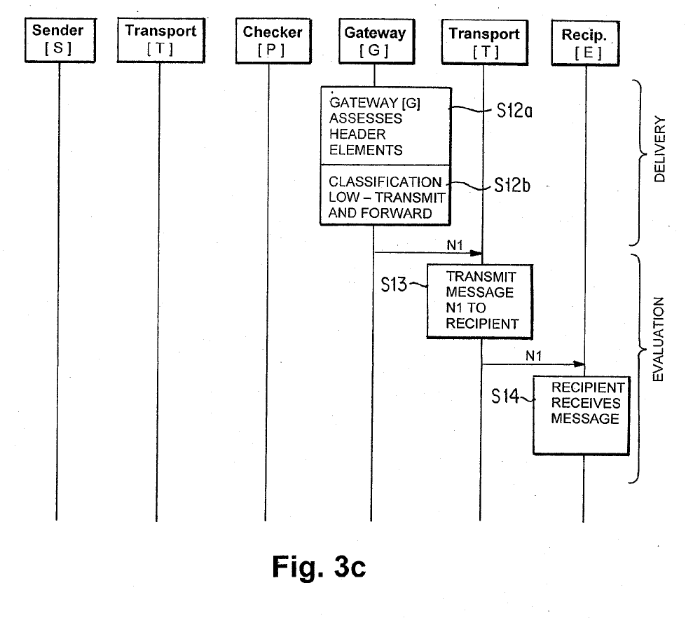

The following steps are carried out with respect to the sequence of operation (FIGS. 3a, 3b, 3c):

1. Sending

2. Transforming and requesting authenticity verification

3. Verifying

4. Assessing

5. Delivering

### 1. Sending

As shown in FIG. 3a, a sender S creates an electronic message N1 and addresses recipient E (S1). He also defines selected header elements HE, such as the subject or security classification. It is possible for the sender to encrypt the message body for the recipient E or to digitally sign the message, using established methods, such as S/MIME or PGP. The transport system T transits (S2) the message N1 on the basis of the address information in the header elements to the checking device P.

### 2. Transforming and Requesting of Authenticity Verification

2A: Receipt and Hash Value Calculation

The checking device P (FIG. 2) receives the message N1 (S2), and by way of the entire message N1, forms a hash value [H] (S3a), using a known method, for example, MD5. This hash value is significantly shorter (for example 1,024 bits) than the message itself and is unambiguous for this one message, so that this hash value H can be used as a code element for filing the message.

2B: Transformation of the Header Elements

In a human readable form, the relevant header elements are transformed into the message body of a new second message N2 (S3b). The header elements HE to be verified with respect to their authenticity are transformed as well as those which the verifier requires for unambiguously recognizing the original message.

The following table shows an example of the header elements which may be taken over into the second message as well as their purpose within the scope of the operation:

| Use for: | Header Element |
|---|---|
| Identification of Message | Recipient |
| ″ | Submission Time |
| ″ | Message ID |
| ″ | Message Size |
| ″ | Number Attachments |
| Authenticity Verification | Security Classification |
| ″ | Priority Level |
| ″ | Validity Period |

In addition, the hash value H is taken over into the message text.

The second message N2 will now be encrypted (S3d) for the sender S of the original message N1, so that only the sender S can carry out the authenticity verification for the original message N1 (because only the sender S and the checking device P know the corresponding hash value H). Optionally, the message N2 can also be provided with a digital signature in addition to the encryption (S3c).

2C: Filing

The original message N1 will be filed (S4) with the hash value H at the checking device P. In this case, the hash value H is used as a code criterion in order to be able to find the message N1 again. For the filing, the point in time of the filing will also be stored.

2D: Sending

The second message N2 will be transmitted to the sender S by means of the transport system T (S5). The author of the original message N1 himself is thereby integrated into the process in order to verify the authenticity of the header elements HE.

### 3. Verifying

3A: Receipt and Checking

Referring now to FIG. 3b, the sender S of the original message N1 receives the second message N2 and decrypts the message body (S6a). The sender S now compares the shown message body, which contains the transformed header elements HE from the original message N1, with the message N1 originally sent by him (S6c). (Optionally, the digital signature is checked—S6b.)

3B: Verifying

If the sender S reaches the conclusion that the header elements HE presented to it are correct (S7), the sender can verify their authenticity sending the hash value H to the checking device P. For this purpose, the sender S generates (S8a) an additional—third—message N3 (normally by the “reply” function to message N2) and addresses the checking device P. In this case, it is sufficient to take over the hash value H into the new message N3 (S8b), including any optional digital signature. Additional elements are not necessary because the hash value H unambiguously identifies the original message. However, if the sender S concludes that the presented header elements HE are manipulated, it is sufficient to take no further action. A negative verification to the checking device P is not necessary. However, it may become necessary on the basis of the applied security policy to report the manipulation of the header elements to a competent body.

3C: Sending

For the verification of the authenticity of the header elements of the original message N1, the sender S delivers the third message N3 to the transport system T for transmitting to the checking device P (S9).

### 4. Assessing

The following principle is applied: If the sender S verifies the authenticity of the data transmitted by means of message N2 by returning the hash value to the checking device, the header elements on which they are based are also considered to be verified.

4A: Receipt

The checking device P receives the third message N3 with the authenticity verification from S. The third message N3 may optionally be provided with a digital signature. If this is so, this signature can now be checked and the checking result can be analyzed.

4B: Extracting

The hash value (H) is extracted from the third message N3 (S10a). By encrypting the message N2 which contained the hash value H, it is sufficiently ensured that only the sender S can have verified the authenticity. By means of the hash value H, the original message N1 is now determined from the file (S10b).

4C: Forwarding

The original message N1 is forwarded (S11) to the gateway G, which can now carry out its checking (S12a) on the basis of verified header elements HE, and after a successful checking (S12b), it is transmitted (S13) to the recipient E (S14).

In the case of FIGS. 3a-3c, it is assumed that the security level of message N1 verified to be authentic was less than the security level maximally permissible according to the current security policy, so that the message N1 can pass from the classified area T1 of the transport network into the unclassified area T2 of the transport network.

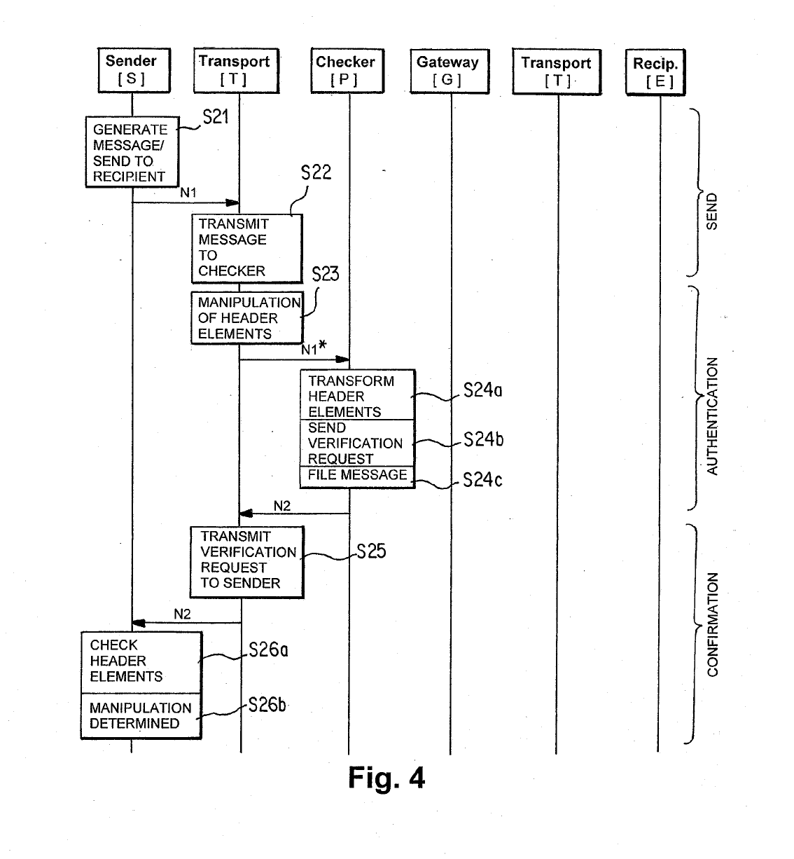

FIG. 4 shows the sequence of the process according to the invention in which there has been a manipulation of the message to be transmitted. The message N1 classified to be confidential is to be sent from the classified area T1 into the unclassified area T2 of the transport network. (Steps S21 and S22 correspond, respectively to steps S1 and S2 in FIG. 3a.) During the transport from the sender S to the checking device P, a manipulation of the header elements of the message takes place (S23) during which the security level is reduced. The manipulated message is called N1*. There is therefore the risk that the confidential information will reach the unclassified area T2 by way of the gateway G.

According to the process of the invention, the checking device P transforms the header element in the manner described above (S24a), files the message (S24c), and sends (S24b) the verification request N2 to the sender S (S25). The sender S checks the header elements (S26a), and determines (S26b) that a deviation exists between the header elements HE of the message N1 (as it is set down in message N2) and the header elements of the message N1 originally sent by him. The manipulation has therefore been recognized. Since the checking device P receives no return message in response to its verification request N2 from the sender S, the message N1* manipulated there will not be forwarded.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A process for transmitting electronic messages, containing protected and unprotected contents between a sender and a recipient via a transmission network, said process comprising:
a checking device connected in said transmission network in front of the recipient receiving and storing an original message sent by the sender;
said checking device generating a second message, which contains, as protected contents, unprotected contents of the original message, including at least data providing an unambiguous identification of the original message, and data, whose accuracy is to be verified by the sender;
said checking device sending the second message to the sender;
said sender receiving the second message sent by the checking device; and
said sender comparing the protected contents of the second message with unprotected contents of the original message;
when the protected content of the second message corresponds to the unprotected content of the first message, said sender sending to the checking device a third message for verifying the authenticity of the original message; and
the checking device forwarding the stored original message to the recipient on upon receiving the third message sent by the sender.

2. The process according to claim 1, wherein:
the transmission network comprises areas of differing security levels;
a gateway checks the transmission of messages between the transmission network areas of different security levels;
the original message contains unprotected data for the security classification of the original message;
the second message contains, as protected contents, data concerning the security classification of the original message; and
after the verification of its authenticity, the checking device forwards the stored original message to the gateway, by which, after a checking has taken place at the gateway, it is forwarded to the recipient.

3. The process according to claim 1, wherein:
the checking device generates a fingerprint of the original message when the original message is received, carries out the storage of the original message with the fingerprint as a defining criterion, and sends the fingerprint to the sender, as a protected content in the second message;
the second sends the fingerprint to the checking device in a third message, for verifying authenticity of the original message; and
the checking device by means of the fingerprint sent with the third message, determines the stored original message.

4. The process according to claim 3, wherein the fingerprint is created by generating a hash value of the original message.

5. The process according to claim 1, wherein the unprotected contents of the original message are contained in a message header and the protected contents are contained in a message body.

6. The process according to claim 1, wherein protection of the protected contents of the second message is implemented by encryption.

7. The process according to claim 6, wherein the protection of the protected contents of the second message is further implemented by a digital signature.

8. The process according to claim 1, wherein the third message is protected by means of a digital signature.
